(19) United States
(12) Patent Application Publication
(10) Pub. No.: US 2007/0016550 A1
(43) Pub. Date: Jan. 18, 2007

(54) Apparatus, system, computer program product and method for displaying parts information

(76) Inventor: Yasutaka Oodake, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/377,522

(22) Filed: Mar. 17, 2006

(30) Foreign Application Priority Data
Jul. 15, 2005 (JP) 2005-207098

(51) Int. Cl. G06F 17/30

(52) U.S. Cl. 707/1

(57) ABSTRACT

A parts information display apparatus includes a parts database; and an action database. The parts database stores a dictionary having an independent property and a dependent property storing an attribute characterizing a classification of parts and a value indicating nature of the property. The parts database also stores an instance of the parts. The action database stores action data defining a display method of the dependent property according to the independent property and the attribute of the dependent property. The apparatus also includes a search unit that searches the parts database with a search condition to acquire a property of corresponding parts data and an instance of the property; a display determining unit that judges whether the property of the parts data corresponds to each of a property included in the instance of the independent property and a property included in the attribute of the dependent property; and a search result output unit that outputs the property and the instance.

### CROSS-REFERENCE TO RELATED APPLICATIONS

This application is based upon and claims the benefit of priority from the prior Japanese Patent Application No. 2005-207098, filed on Jul. 15, 2005; the entire contents of which are incorporated herein by reference.

### BACKGROUND OF THE INVENTION

1. Field of the Invention

The present invention relates to an apparatus, a system, a computer program product, and method for displaying a parts information.

2. Description of the Related Art

A hierarchical database, which is exemplified by an object-oriented database (OODB) and an object relational database (ORDB), has a hierarchical structure in which lower classes inherit properties of upper classes. In such a hierarchical database, the number of properties of the lower classes increases with successions from the upper classes. The successions of the properties of the upper classes to the lower classes are generally called “inheritance,” the feature of which is described, for example, in “Object-Oriented Concepts, Databases, and Applications,” edited by Won Kim, 1989, ACM Press.

In the OODB, a unit of classification is generally called a “class.” On the other hand, in the ORDB, a table that permits the inheritance corresponds to the class in the OODB. Between the tables with a hierarchical relation, the properties are inherited from upper tables to lower tables, in other words, header information constituting an upper table is inherited to a lower table. Data having the same type of property and belonging to a certain class of each level is called an “instance,” and a collection thereof is called a “population.” The population of data is usually stored in a structure called table in a relational database (RDB) or an ORDB.

One known hierarchical database is defined by ISO13584 Parts Library Standard (hereinafter simply referred to as “PLIB” standard), which is an international standard for implementing an electronic catalogue system which electronically providing product information. The “PLIB” standard is an international standard composed of a plurality of “Parts” and defines a manner of object-oriented description of products library data or parts library data and a semantics for file exchange, in other words, defines what kind of terms, manner of description, and data type are to be employed. Part 42 (Part Issue No. 42) of the PLIB has same contents with the IEC61360-2 (Part Issue No. 2). The standard specifies rules that classify products in an object-oriented manner, and clarify a group of properties characterizing each class, and defines the file exchange format of the contents corresponding to the class. Further, since the standard is formulated based on the ISO6523 “Structure for Identification of organizations and organization parts,” with the use of the International Code Designator (ICD) defined by ISO 6523, in particular, an internationally unique identifier can be allocated to each property.

In recent years, systems based on the PLIB standard are implemented, for example, in Japanese Patent Application Laid-Open No. 2004-177996, and Japanese Patent Application Laid-Open No. 2004-178015.

The PLIB standard defines that only one unit of measurement can be allowed in one property. Therefore, if pieces of products/parts data whose units are different are to be managed in the same class, either of the following methods needs to be employed,

Method 1: A method of converting a unit of original data to a unified unit and registering a value

Method 2: A method of registering “value” and “unit name” as separate properties

In an electronic catalogue management system described in Japanese Patent Application Laid-Open No. 2005-018294, there has been proposed a technique of unifying variation in the unit by automatically converting values of the product parts information data provided by catalogue suppliers into a corresponding unit defined in a dictionary on the user side.

According to Method 1 or the technique disclosed in Japanese Patent Application Laid-Open No. 2005-018294, however, the value normalized into the common unit may be inconsistent with that in the original unit due to an error of conversion accuracy or the like, which can cause misunderstanding of a viewer.

Furthermore, it is of a problem in terms of PL (product liability) that a system or a data registrant corrects a value based on the original unit without permission.

On the other hand, in the case of Method 2, since the unit is not unified, it has a problem in that visual comparison by a viewer during listing or in that searching by the system with this property used as a key is difficult.

These problems may arise not only in the case of unit conversion, but may arise similarly in conversion of “compliance standard” with which a products or a parts complies (e.g. a standard with which the strength of “screw”) or the like complies.

### SUMMARY OF THE INVENTION

According to one aspect of the present invention, a parts information display apparatus includes a parts database and an action database. The parts database is configured to store a dictionary which has an independent property and a dependent property which has a dependency in which a value thereof is determined by the independent property, and which stores an attribute which defines a property characterizing a classification of parts and a value indicating nature of the property; and an instance which has an instance value which is information of the parts described according to the dictionary. The action database is configured to store action data defining a display method of the dependent property according to an instance value of the independent property and a value of the attribute of the dependent property. The apparatus also includes a search condition input unit configured to input a search condition; a search unit configured to search the parts database with the search condition to acquire a property of corresponding parts data and an instance of the property; a display determining unit configured to determine whether the property of the parts data corresponds to each of a property included in the instance value of the independent property and a property included in the value of the attribute of the dependent property, whose display method is defined in the action database, to determine the display method of the dependent property; and a search result output unit configured to output the property of the parts data and the instance of the property which are acquired by the search unit, according to the display method of the dependent property.

According to another aspect of the present invention, a parts information display apparatus includes a parts database and an action database. The parts database is configured to store a dictionary which has a class defining a hierarchical structure of parts data, an independent property, and a dependent property which has a dependency in which a value thereof is determined by the independent property, and which stores a property which defines nature of the class and an attribute which defines values indicating nature of the class and the property, the dictionary having a hierarchical structure in which a lower classification class inherits a property of an upper classification class; and an instance which has an instance value which is information of the parts described according to the dictionary. The action database is configured to store action data defining a display method of the dependent property according to an instance value of the independent property and a value of the attribute of the dependent property. The apparatus also includes a search condition input unit configured to input a search condition; a search unit configured to search the parts database with the search condition to acquire a property of corresponding parts data and an instance of the property; a display determining unit configured to determine whether the property of the parts data corresponds to each of a property included in the instance value of the independent property and a property included in the value of the attribute of the dependent property, whose display method is defined in the action database, to determine the display method of the dependent property; and a search result output unit configured to output the property of the parts data and the instance of the property which are acquired by the search unit, according to the display method of the dependent property.

According to still another aspect of the present invention, a parts information display system includes a parts database and an action database. The parts database is configured to store a dictionary which has an independent property and a dependent property which has a dependency in which a value thereof is determined by the independent property, and which stores an attribute which defines a property characterizing a classification of parts and a value indicating nature of the property; and an instance which has an instance value which is information of the parts described according to the dictionary. The action database is configured to store action data defining a display method of the dependent property according to an instance value of the independent property and a value of the attribute of the dependent property. The system also includes an input unit configured to allow a viewer to input a search condition; a search condition input unit configured to input the search condition; a search unit configured to search the parts database with the search condition to acquire a property of corresponding parts data and an instance of the property; a display determining unit configured to determine whether the property of the parts data corresponds to each of a property included in the instance value of the independent property and a property included in the value of the attribute of the dependent property, whose display method is defined in the action database, to determine the display method of the dependent property; a search result output unit configured to output the property of the parts data and the instance of the property which are acquired by the search unit, according to the display method of the dependent property; and a output unit configured to display the property of the parts data and the instance of the property which are acquired by the search unit and are output according to the display method of the dependent property.

According to still another aspect of the present invention, a parts information display system includes a parts database and an action database. The parts database is configured to store a dictionary which has a class defining a hierarchical structure of parts data, an independent property, and a dependent property which has a dependency in which a value thereof is determined by the independent property, and which stores a property which defines nature of the class and an attribute which defines values indicating nature of the classes and the property, the dictionary having a hierarchical structure in which a lower classification class inherits a property of an upper classification class; and an instance which has an instance value which is information of the parts described according to the dictionary. The action database is configured to store action data defining a display method of the dependent property according to an instance value of the independent property and a value of the attribute of the dependent property. The system also includes an input unit configured to allow a viewer to input a search condition; a search condition input unit configured to input the search condition; a search unit configured to search the parts database with the search condition to acquire a property of corresponding parts data and an instance of the property; a display determining unit configured to determine whether the property of the parts data corresponds to each of a property included in the instance value of the independent property and a property included in the value of the attribute of the dependent property, whose display method is defined in the action database, to determine the display method of the dependent property; a search result output unit configured to output the property of the parts data and the instance of the property which are acquired by the search unit, according to the display method of the dependent property; and a output unit configured to output the property of the parts data and the instance of the property which are acquired by the search unit and are output according to the display method of the dependent property.

According to still another aspect of the present invention, a parts information display method includes creating a parts database configured to store a dictionary which has an independent property and a dependent property which has a dependency in which a value thereof is determined by the independent property and which stores an attribute which defines a property characterizing a classification of parts and a value indicating nature of the property, and an instance which has an instance value which is information of the parts described according to the dictionary; creating an action database configured to store action data defining a display method of the dependent property according to an instance value of the independent property and a value of the attribute of the dependent property; receiving a search condition; searching the parts database with the search condition to acquire a property of corresponding parts data and an instance of the property; judging whether the property of the parts data corresponds to each of a property included in the instance value of the independent property and a property included in the value of the attribute of the dependent property, whose display method is defined in the action database, to determine the display method of the dependent property; and outputting the property of the parts data and the instance of the property which are acquired by the search unit, according to the display method of the dependent property.

According to still another aspect of the present invention, a parts information display method includes creating a parts database configured to store a dictionary which has a class defining a hierarchical structure of parts data, an independent property, and a dependent property which has a dependency in which a value thereof is determined by the independent property and which stores a property which defines nature of the class and an attribute which defines values indicating nature of the class and the property, the dictionary having a hierarchical structure in which a lower classification class inherits a property of an upper classification class, and an instance which has an instance value which is information of the parts described according to the dictionary; creating an action database configured to store action data defining a display method of the dependent property according to an instance value of the independent property and a value of the attribute of the dependent property; receiving a search condition; searching the parts database with the search condition to acquire a property of corresponding parts data and an instance of the property; judging whether the property of the parts data corresponds to each of a property included in the instance value of the independent property and a property included in the value of the attribute of the dependent property, whose display method is defined in the action database, to determine the display method of the dependent property; and outputting the property of the parts data and the instance of the property which are acquired by the search unit, according to the display method of the dependent property.

A computer program product according to still another aspect of the present invention causes a computer to perform any one of the parts information display methods according to the present invention.

### BRIEF DESCRIPTION OF THE DRAWINGS

FIG. 1 is a schematic diagram showing a system construction example of a parts information display system according to a first embodiment of the present invention;

FIG. 2 is a diagram of a module structure of a server;

FIG. 3 is a block diagram showing a schematic structure of the system including the server;

FIG. 4 is a schematic diagram showing one example of a dictionary stored in a hierarchical database;

FIG. 5 is a schematic diagram showing examples of instances according to the dictionary of FIG. 4;

FIG. 6 is a schematic diagram showing other examples of instances according to the dictionary of FIG. 4;

FIG. 7 is a schematic diagram showing examples of property-attribute condition action data;

FIG. 8 is a flowchart showing a flow of processing in a display determining unit;

FIG. 9 is an explanatory diagram showing a result obtained by applying this embodiment to all the instances shown in FIG. 5;

FIG. 10 is an explanatory diagram showing a result obtained by applying this embodiment to all the instances shown in FIG. 6;

FIG. 11 is a block diagram showing a schematic structure of a system including a server according to a second embodiment of the present invention;

FIG. 12 is an explanatory diagram showing a result when a viewer specifies independent properties (Q3 and Q4); and

FIG. 13 is an explanatory diagram showing a result when the viewer specifies a dependent property (Q7).

### DETAILED DESCRIPTION OF THE INVENTION

Exemplary embodiments of a parts information display apparatus, a parts information display system, a parts information display program, and a parts information display method according to the present invention will be described in detail below with reference to the accompanying drawings.

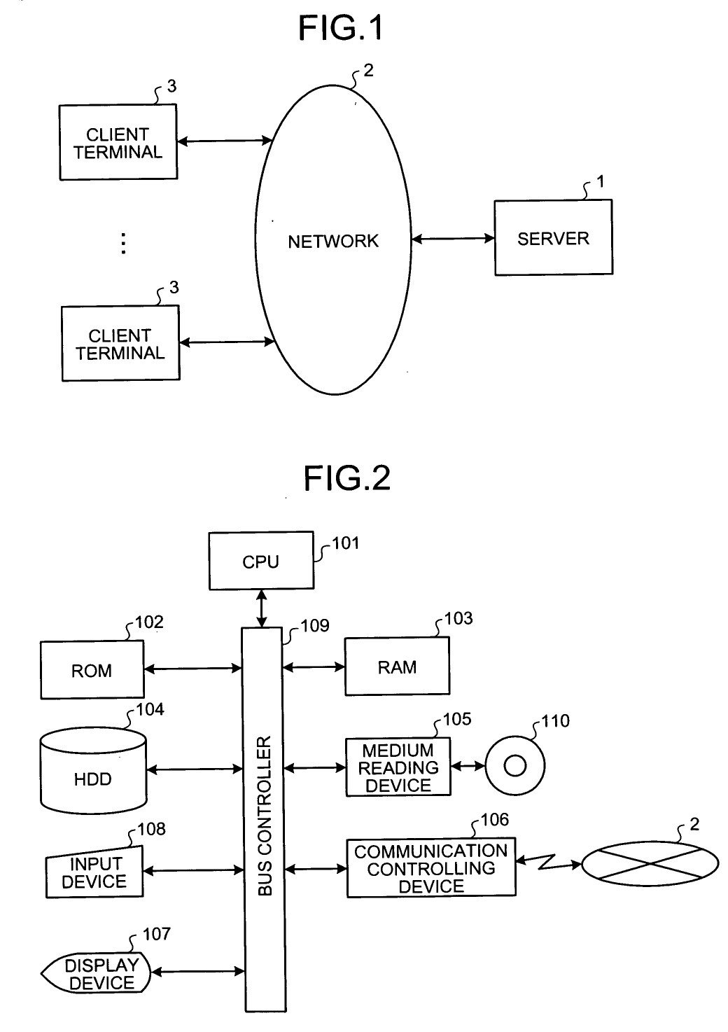

FIG. 1 is a schematic diagram showing a system construction example of a parts information display system according to a first embodiment of the present invention. The system, as shown in FIG. 1, is assumed to be a server-client system where a server computer 1 (hereinafter simply referred to as a server) which is a parts information display apparatus, is connected to plural client computers 3 (hereinafter simply referred to as client terminals) which are terminal devices via a network 2 such as a Local Area Network (LAN) or the like. It goes without saying that the present invention is not limited only to the client/server system involving such network communications.

The client terminal 3 is a general personal computer or the like, which can transmit or receive data with respect to the server 1 by using a WEB browser. This client terminal 3 functions as an administrator terminal for an administrator to register information of a product parts through, and a viewer terminal for a viewer of the product parts information to search through. Namely, the client terminal 3 is an input and output device for the server 1 which is a parts information display apparatus.

FIG. 2 is a diagram of a module structure of the server 1. The server 1 which is the parts information display apparatus includes a central processing unit (CPU) 101 which performs information processing, a read only memory (ROM) 102 which stores BIOS or the like and is a dedicated memory for reading out, a random access memory (RAM) 103 which rewritably stores various data, a hard disk drive (HDD) 104 which functions as various databases and stores various programs, a media drive 105, such as a CD-ROM drive, which serves to store information, externally distribute information, and externally acquire information, using a storing medium 110, a communication controlling device 106 that serves to transmit information to/from other external computer via the network 2, a display device 107 such as a cathode ray tube (CRT), or a liquid crystal display (LCD) that displays condition of processing and results of processing to an operator, and an input device 108, such as a keyboard or a mouse, which serves to receive input such as a command or information from the operator to supply the same to the CPU 101, and the data transmitted among the respective units are arbitrated by a bus controller 109.

When the power of the server 1 is turned on by the user, the CPU 101 starts up a program called loader inside the ROM 102, to read out an operating system (OS) which is a program for managing a hardware and a software of the computer from the HDD 104 to the RAM 103, and starts up the OS. The OS serves to activate a program, read in information, and store information according to a manipulation by the user. Known typical OS are, for example, Windows (registered trademark), and UNIX (registered trademark). A program running on the OS is called an application program. The application program is not limited to those running on a predetermined OS and may be a program that let the OS execute a part of various processing described later. Still alternatively, the application program may be included in a group of program files making up a predetermined application software or an OS.

Here, the server 1 stores the parts information display program in the HDD 104 as an application program. In this sense, the HDD 104 functions as a storing medium that stores the parts information display program.

A program installed in the HDD 104 of the server 1 is generally recorded in the storing medium 110 such as an optical disk such as a CD-ROM, or a DVD, various magneto-optical disk, various magnetic disk such as a flexible disk, a media of various recording schemes such as a semiconductor memory, and the program stored in the storing medium 110 is installed into the HDD 104. Here, a portable storing medium 110 such as an optical information recording medium such as a CD-ROM, or a magnetic media such as an FD can be employed as, a storing medium that stores a parts information display program. Further, the parts information display program may be taken in from outside via the communication controlling device 106, for example, and installed into the HDD 104.

When the parts information display program running on the OS is started up, the server 1 follows the parts information display program, and the CPU 101 executes various operations to collectively control the respective units. Among the various operations executed by the CPU 101 of the server 1, characteristic processing of the first embodiment executed according to the parts information display program will be described below.

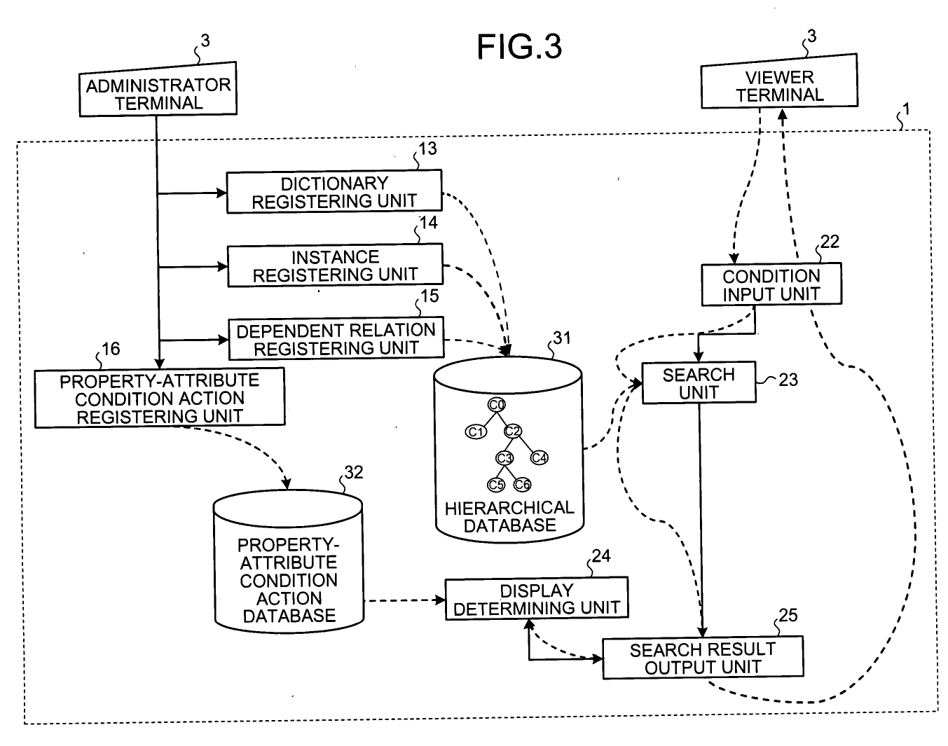

FIG. 3 is a block diagram showing a schematic structure of the system including the server 1. As shown in FIG. 3, by the control of the CPU 101 over the respective units according to the parts information display program, the server 1 is provided with a hierarchical database 31 which is a parts database, a property-attribute condition action database 32 which is an action database, a dictionary registering unit 13, an instance registering unit 14, a dependency registering unit 15, a property-attribute condition action registering unit 16, a search condition input unit 22 which is search condition input means, a search unit 23 which is search means, a display determining unit 24 which is display determining means, and a search result output unit 25 which is search result display means. Hereinafter, these respective functions will be described.

Functions utilized for maintaining and managing the databases are first described.

In the hierarchical database 31, there are stored a dictionary of product parts (i.e. classes and properties characterizing each class of each parts), and concrete information (called instance) of the product parts described according to the dictionary. The dictionary registering unit 13 fulfils the function of registering a dictionary input by an administrator from the client terminal 3 functioning as an administrator terminal, and the instance registering unit 14 fulfils the function of registering an instance input by the administrator from the client terminal 3 functioning as the administrator terminal. Further, there can be a dependency that a certain property value is determined by one or more properties, among the properties. The dependency registering unit 15 fulfils the function of registering, in the hierarchical database 31, a dependency input by the administrator from the client terminal 3 functioning as the administrator terminal. In the property-attribute condition action database 32, there is stored property-attribute condition action data which is an action regarding a display method of the dependent property among the properties having the dependency. The property-attribute condition action registering unit 16 fulfils the function of storing, in the property-attribute condition action database 32, the property-attribute condition action data which is an action regarding a display method of the dependent property input by the administrator from the client terminal 3 functioning as the administrator terminal.

Next, functions utilized by the viewer are described.

The search condition input unit 22 fulfils the function of receiving a search condition input by the viewer from the client terminal 3 functioning as a viewer terminal. The search unit 23 fulfils the function of searching the hierarchical database 31 using the search condition received by the search condition input unit 22. The display determining unit 24 fulfils the function of determining the display method of properties to be displayed in reference to the property-attribute condition action database 32. The search result output unit 25 fulfils the function of actually performing the display based on the search result in the search unit 23 and the display method determined by the display determining unit 24.

Next, the data structures of the dictionary and the instance stored in the hierarchical database 31 will be described.

First, the data structure of the dictionary stored in the hierarchical database 31 is described.

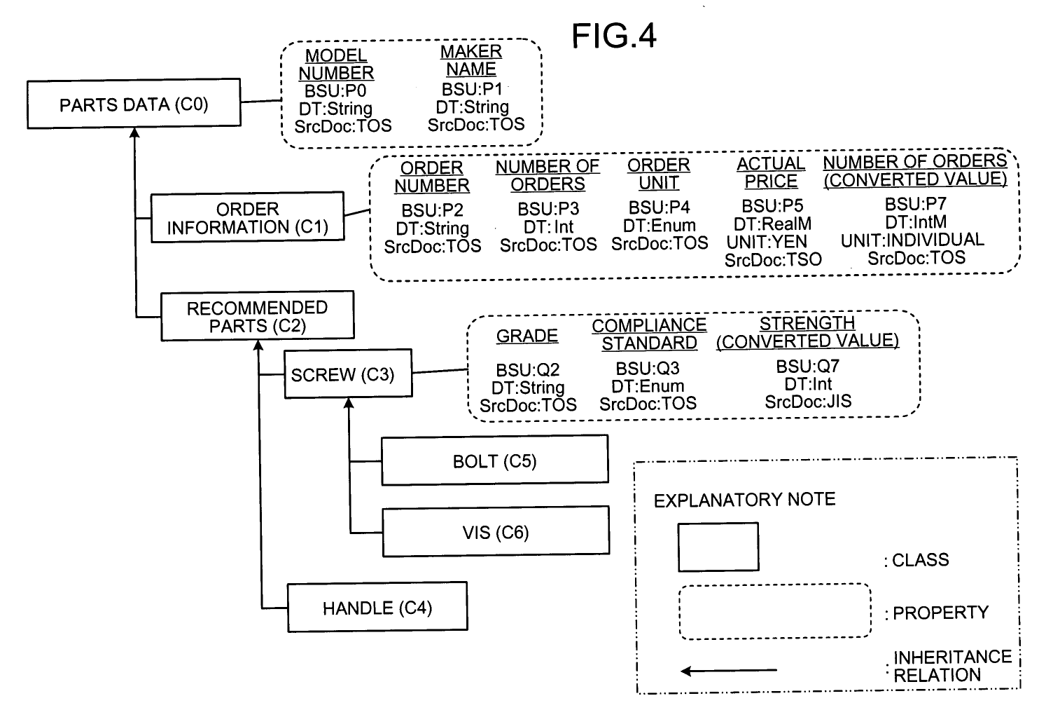

FIG. 4 is a schematic diagram showing one example of the dictionary stored in the hierarchical database 31. The dictionary shown in FIG. 4 has a hierarchical structure in which a class of “parts data” is a root class and “order information” and “recommended parts” are associated with the root class as child classes. Namely, it shows that “parts data” is classified into two classes of “order information” and “recommended parts”. Similarly, “recommended parts” is classified into “screw” and “handle”, and “screw” is classified into “bolt” and “vis.” The hierarchical structure may have any number of tiers. Reference signs written in parentheses (in this case, C1-C6) are codes each indicating a class labeled uniquely in the dictionary (here, referred to as “class BSU code”).

As shown in FIG. 4, in each of the classes defining the hierarchical structure, specific properties (portions surrounded by dashed line in FIG. 4) are defined. Each of the classes inherits properties defined in the upper classes of the relevant class. For example, property items owned by the class “screw” are properties defined in the upper class “parts data” (“model number,” “manufacturer”), a property defined in the class “recommended parts” (in this case, absent), and properties defined in the class “screw” (“grade,” “compliance standard,” “strength (converted value).” As in the class, a code indicating the property, and labeled uniquely in the dictionary (“property BSU code” or simply “BSU code”) is given.

Furthermore, an attribute which is a detailed information field of the class and the property (i.e. defines nature of the property) is given to each of the properties. The BSU code itself and the names themselves such as the “model number” and the “manufacturer” are examples of attributes. In addition, a data type (DT:) and a source of the property (SrcDoc:), and in the case of a data type with a unit, a unit name (Unit:) and the like are attributes. These attributes are predefined. Furthermore, for the data type (DT:), a string type (String), an integer type (Int), a real number type (Real), an integer-with-unit type (IntM), an real-number-with-unit type (RealM), an enumeration type (Enum) and the like are defined. For example, for the property “number of orders (converted value)” shown in FIG. 4, values of the attributes such as “name: number of orders (converted value),” “property BSU code: P7),” “data type: integer-with-unit type,” “unit name: PCS,” and “source of property: TOS” are defined.

As one of data models defining dictionary structures such as a parent-child structure of classes, items of properties and attributes thereof and data types, ISO13584/Parts Library (PLIB) which is an international standard for exchange format of the above-described product parts library is exemplified.

While, in the present embodiment, a description is given using an application example to the hierarchically-structured database according to the PLIB model, this limitation does not prevent the present invention from being applied to databases other than the PLIB.

Next, the data structure of the instance stored in the hierarchical database 31 is described.

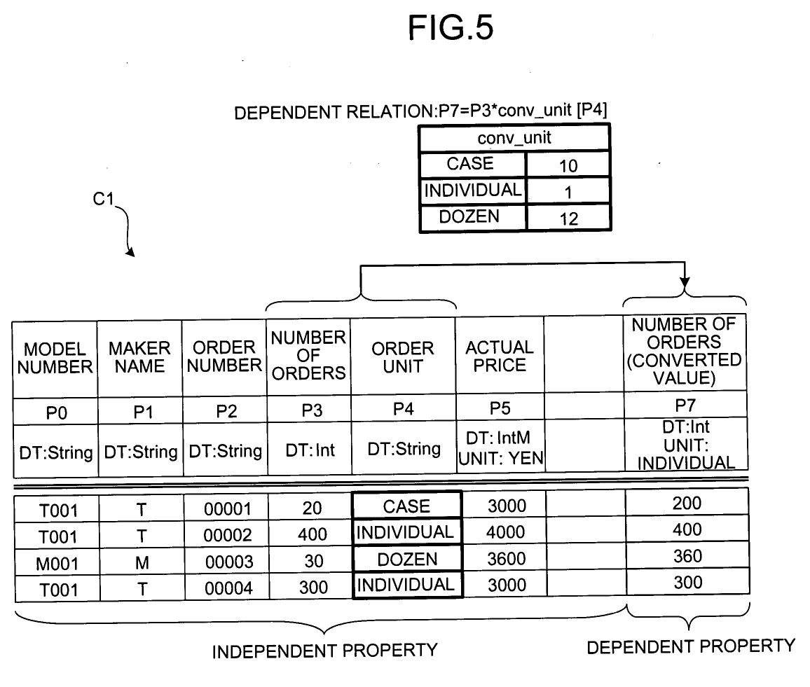

FIG. 5 is a schematic diagram showing examples of the instances according to the dictionary of FIG. 4. FIG. 5 shows instances belonging to the class “order information (C1).” The respective instances show articles which were ordered by a user company of the parts in past times. In the examples shown in FIG. 5, the actual quantity of orders is represented by the combination of “number of orders (P3)” and “order unit (P4).” The unit of the quantity of orders is frequently varied for each order in actual business. In the case of the dictionary according to the PLIB model, only one unit is allowed for each property, and thus, if the instances whose units are different are to be stored, the above-described representation is employed. Accordingly, since it is difficult to compare the quantities as they are, the units of the quantities are generally unified into a standard unit to represent the quantities. Consequently, the property prepared for conversion to the standard unit is “number of orders (converted value)(P7).” In this property, the unit name (Unit) is “PCS”. Here, the property “number of orders (P3)” and the property “order unit (P4)” are each called independent property, and the property having a dependency that a value thereof is determined by one or more independent properties is called dependent property. “Number of orders (converted value) (P7)” is a dependent property. The dependency between P3 and P4 which are independent properties and their dependent property P7 is expressed as follows:
P7=P3*conv_unit[P4]
A value calculated by this conversion formula is put into the cell of P7.

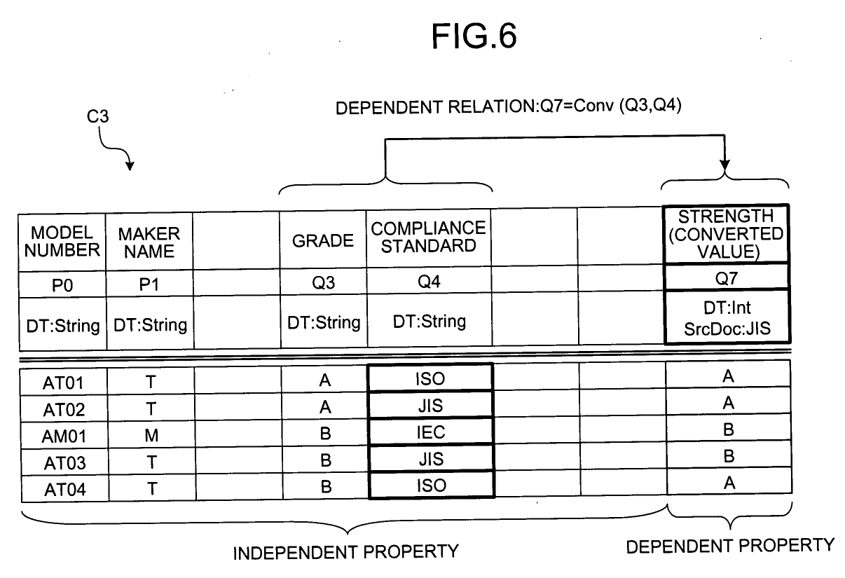

FIG. 6 is a schematic diagram showing other examples of the instances according to the dictionary of FIG. 4. FIG. 6 shows the instances belonging to the class “screw (C3).” Each of the instances indicates a recommended instance utilized by the user company of the parts, for example. In the examples shown in FIG. 6, for the strength of “screw,” the compliance standards of the respective parts are different, and the strength of “screw” is represented by a pair of “compliance standard (Q4)” and “grade (Q3).” An instance value of Q4 takes any value of JIS, ISO and IEC. In order to compare the actual strength, a compliance standard as a reference needs to be decided to use a common criterion. Therefore, a property “strength (converted value) (Q7)” according to the JIS standard is prepared. A dependency between Q3, Q4 which are independent properties and their dependent property Q7 is expressed as follows:
Q7=Conv(Q3, Q4)
In the relation Conv, the conversation is performed as follows:

if (“A”, “ISO”) or (“B”, “ISO”), then Q7=“A”;

if (“A”, “IEC”), then Q7=“B”; and

if (“B”, “IEC”), then Q7=“B.”

A value calculated by the conversion formula is put into the cell of Q7.

Next, a data structure of the property-attribute condition action data stored in the property-attribute condition action database 32 will be described.

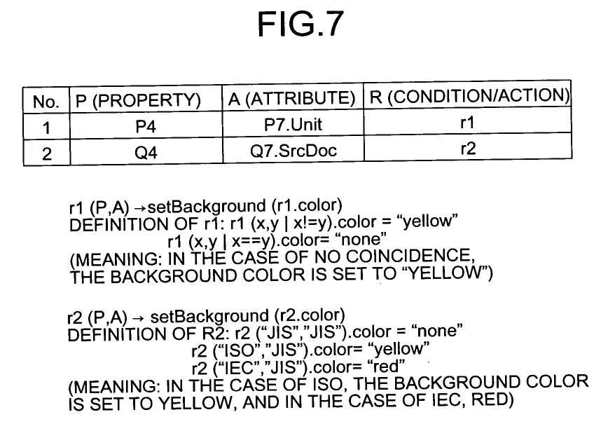

FIG. 7 is a schematic diagram showing one example of the property-attribute condition action data. As shown in FIG. 7, the property-attribute condition action data stored in the property-attribute condition action database 32 is constructed as a set of three types of information of P(property), A(attribute) and R(condition/action). In a P field (property), a property BSU code of the independent property is specified. In an A(attribute) filed, an, attribute name owned by the dependent property of the P(property) field is specified. Depending on how the instance value of the property specified in the P(property) field and a value defined in the dictionary with respect to the attribute specified in the A(attribute) field are different, for the dependent property to which the attribute specified in the A(attribute) field belongs, the display method of the cell is changed. The above-described specification of the display method is performed in an R field.

The property-attribute condition action data of No. 1 shown in FIG. 7 is an example of the unit display, and based on how different the instance value of the order unit (P4) which is an independent property and the value of the Unit attribute (i.e. “PCS”) defined in the dictionary, of the number of orders (converted value) (P7) which is a dependent property are, a display background color of the cell of P7 is defined as follows:

r1(P, A)→setBackground(r1. color)

where the definition of r1 in R(condition/action) is as follows:

r1(x, y|x≠y).color=“yellow”

r1(x, y|x=y).color=“none”

which means that if the instance value of P4 does not coincide with the value of P7.Unit, then the background color is set to yellow and if it coincides, the background color is set to be unchanged.

On the other hand, the property-attribute condition action data of No. 2 shown in FIG. 7 is an example of the compliance standard display, and based on how different the instance value of the compliance standard (Q4) which is an independent property and the value of the SrcDoc attribute (i.e. “JIS”) defined in the dictionary, of the strength(converted value) (Q7) which is a dependent property are, a display background color of the cell of Q7 is defined as follows:

r2(P, A)→setBackground(r2. color)

where the definition of r2 in R(condition/action) is as follows:

r2(“JIS”, “JIS”).color=“none”

r2(“ISO”, “JIS”).color=“yellow”

r2(“IEC”, “JIS”).color=“red”

which means that if the instance value of Q4 is “JIS,” the background color of the cell of Q7 is set to be unchanged, if it is “ISO,” the background color of the cell of the Q7 is set to “yellow,” and if it is “IEC,” the background color is set to “red.” This constitution is intended to call the viewer's attention, for example, by setting the background color to “red” when conversion is performed such that ambiguity remains between JIS and IEC, although a strict conversion rule can be applied between JIS and ISO.

While in the example shown in FIG. 7, changing the background color (setBackground( )) which is equivalent to switching the format of the background regarding the display of the dependent property as an action is described, the present invention is not limited to this. For example, there is also enabled an action of calling the viewer's attention by the change in character font or the change in character color which is equivalent to switching the format of the foreground regarding the display of the dependent property, or “balloon display” in which specified words are displayed with a pop-up when a mouse cursor is placed over the display field of the dependent property.

Next, the function of searching for the product parts information by the viewer, which is a characteristic function among the functions fulfilled by the respective units included by the server 1 as the parts information display apparatus, will be described in detail.

In prior to the search for the product parts information by the viewer, the administrator inputs the dictionary shown in FIG. 4, the instances shown in FIG. 5 and FIG. 6 and the dependencies shown in FIG. 5 and FIG. 6 to register them in the hierarchical database 31 by the dictionary registering unit 13, the instance registering unit 14 and the dependency registering unit 15, respectively, via the client terminal 3 functioning as the administrator terminal. Further, for the dependencies input by the administrator via the client terminal 3 functioning as the administrator terminal, that is, arbitrary sets of properties registered from the dependency registering unit 15, the property-attribute condition action data composed of “property”-“attribute”-“R(condition/action)” is registered in the property-attribute condition action database 32 from the property-attribute action registering unit 16.

The function of searching the product parts information by the viewer will be described below.

The viewer inputs a search condition via the client terminal 3 functioning as input means permitting the input of the search condition by the viewer. When the input search condition is received in the search condition input unit 22, the search unit 23 searches the hierarchical database 31 using the search condition received in the search condition input unit 22 to send the result to the search result output unit 25. The search result output unit 25 sends the display determining unit 24 information as to which properties (referred to as “object properties” and indicated by P(c)) are used to describe each instance (c), or the like. For example, as shown in FIG. 5, when the class C1 is specified and searched using a property condition of nil, all of the instances shown in FIG. 5 are passed over to the search result output unit 25. The search result output unit 25 extracts the respective instances to send the display determining unit 24. The display determining unit 24 searches the property-attribute condition action data to determine an appropriate display method for the dependency property.

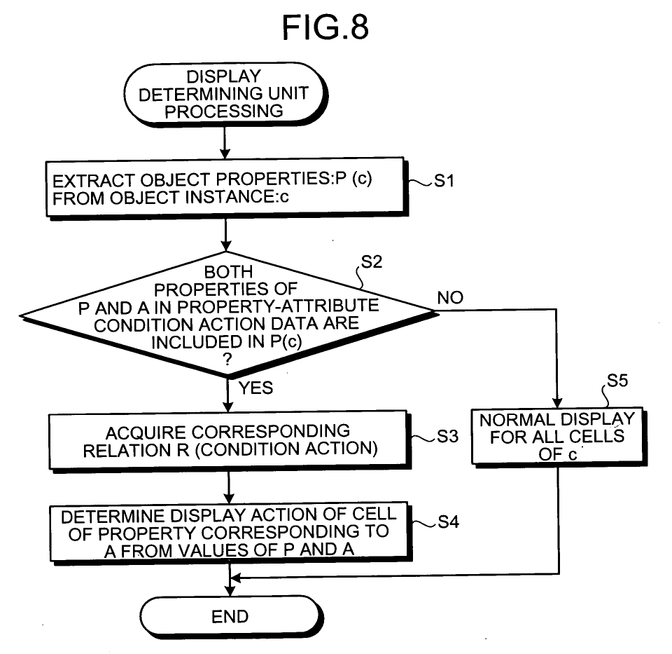

Now, processing in the display determining unit 24 is described in detail in reference to a flowchart of FIG. 8. Here, an instance of P2=00001 in FIG. 5 is described as an object instance c.

As shown in FIG. 8, first, an object property row p(c) as shown below is extracted from the object instance c (step S1):

Object property row p(c)={P0, P1, P2, P3, P4, P5, P7}

Next, a record in which any properties of the object property row p(c) are included in both values of the property names of P(property) and A(attribute) is searched from the property-attribute condition action database 32 (step S2).

If there is a record in which any properties of the object property row p(c) are included in both values of the property names of P(property) and A(attribute) (Yes in step S2), then corresponding R(condition/action) is acquired (step S3).

When the instance of P2=00001 in FIG. 5 is the object instance c, P4 and P7 match the record of No. 1, so that r1 is acquired as R(condition/action).

Next, according to the acquired R(condition/action), a concrete display method of the cell is determined to output it to the client terminal 3 functioning as display means (step S4).

Here, the display method of the cell is determined from the relation between the value of P4, that is, “case,” and the Unit attribute of P7, that is, “pcs,” based on the relation of r1. In this case, since the instance value of P and the value of the attribute of A are different, the background color (setBackground) is determined so as to be “yellow” and the result is output to the client terminal 3 functioning as the display means.

On the other hand, if there is no record in which any of the properties are included in both of the values of the property names of P(property) and A(attribute) (No in step S2), all cell display is set to normal display, which is output to the client terminal 3 functioning as the display means (step S5), and the processing is finished.

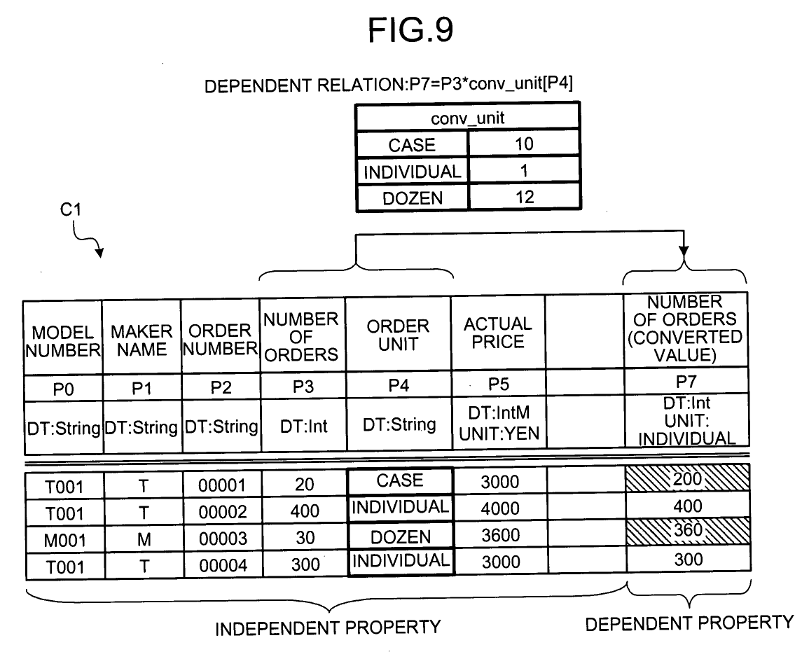

The search result output unit 25 applies the above-described processing to all the object instances c shown in FIG. 5 to thereby determine the display method for the cells of the dependent property. The result obtained by applying the processing to all the instances shown in FIG. 5 is shown in FIG. 9. As shown in FIG. 9, by comparing the instance value of the independent property and the value of the Unit attribute of the dependent property, the background of the cell where both of the values are different in the comparison result becomes “yellow.”

This constitution can provide the mechanism which allows the viewer to pay attention to the value (cell) whose unit has been automatically converted by the system according to the dependency. Furthermore, this mechanism is also effective in terms of PL (product liability) when applied to unit conversion of a numeric value including an effective digit.

Next, a further description is given to show that the present invention brings about an effect similar to that of the Unit attribute by utilizing another attribute. Here, on the premise that the class C3 is searched for and as a result, the instances shown in FIG. 6 are obtained, a case where P0=AT01 is used as the object instance c selected by the search result output unit 25 is described.

First, the object property row p(c) as shown below is extracted from the object instance c (step S1):

Object property row p(c)={P0, P1, P2, P3, P4, P5, P7}

When the property-attribute condition action database 32 is searched, Q4 and Q7 match and thus, r2 is selected as R(condition/action) (steps S2, S3). The display method of the cell is determined from the relation between the value of Q4, that is, “ISO” and the SrcDoc attribute of Q7, that is, “JIS” based on the relation of r2. In this case, by directly referring to the relation table, the following can be understood:

r2(“ISO”, “JIS”).color=“yellow.”

Namely, it is understood that the display color is set to “yellow”, and the background color of Q7 can be determined so as to be yellow, based on the following (step S4):

r2(P,A).color→setBackground(r2. color)

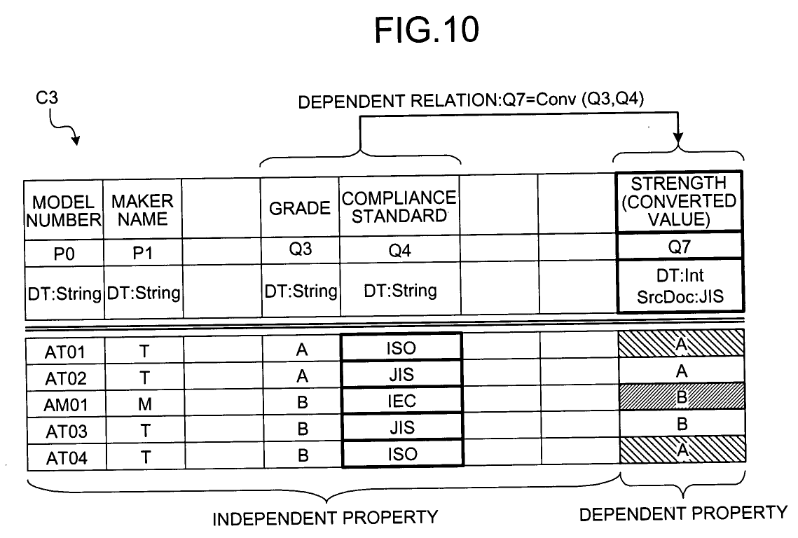

The result obtained by applying to all the instances shown in FIG. 6 is shown in FIG. 10. In the case of the instance of P0=AM01, it is determined to set the background color to “red” by performing the above-described processing.

Thus, by performing the similar processing to that described in the conversion of the unit, there can be provide a mechanism which promotes the viewer to pay attention when ambiguity remains when the compliance standard is automatically converted by the system based on the dependency.

The above-described method can be applied to not only the specific attributes such as Unit and SrcDoc but attributes of various properties. The point of this method is to switch the display of the instance value of the dependent property according to the matching criterion between the specific attribute value of the dependent property and the instance value of the independent property.

This display method can also be applied to a product parts belonging to the lower class. Now, this case is described. While, when C3 is searched for, the result as shown in FIG. 10 is obtained, the properties of Q3, Q4 and Q7 are inherited by C5 and C6 which are lower classes of C3. Accordingly, the dependency is also inherited, and the corresponding property-attribute condition action data can also be applied. For example, even when an instance is searched for with C5, the condition/action of r2 shown in FIG. 7 can be applied to the display method of the result.

Thus, according to the present embodiment, the hierarchical database 31 is searched using an received search condition to acquire properties of corresponding parts data and its instance, and it is judged whether or not the acquired properties of the parts data correspond to both properties included in an instance value of an independent property and a value of an attribute of a dependent property, whose display method is defined in the property-attribute condition action database 32, and the display method of the dependent property is determined, and according to the determined display method of the dependent property, the properties of the parts data and its instance which have been acquired are output to be displayed. Thereby, the display method of the dependent property is defined such that the viewer can see that the displayed value of the dependent property is a value obtained by the automatic conversion by the system, even when the conversion of, for example, the unit or the compliance standard is automatically performed by the system by using the dependent property having a dependency with the independent property. This enables the display giving less misunderstanding to the viewer while respecting the description of the original data.

While in the present embodiment, a description has been given using the hierarchical database, this embodiment can be applied to a flat-structured database instead of the hierarchical database, except for the case where the property-attribute condition action data is inherited to the lower classes as described last.

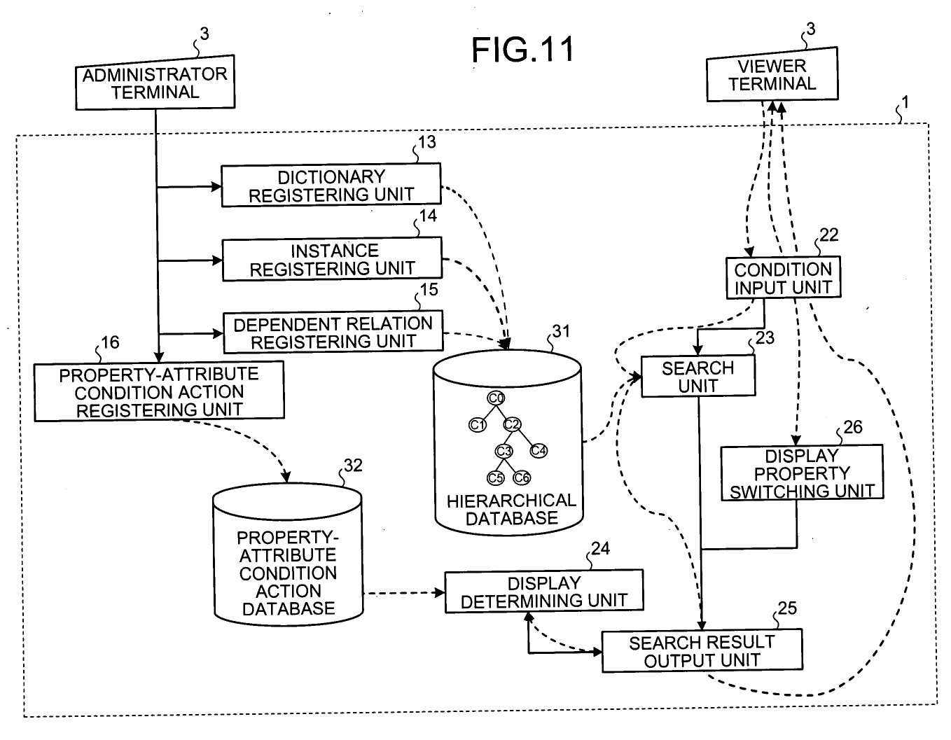

Next, a second embodiment of the present invention will be described with reference to FIGS. 11 to 13. The same components as in the first embodiment described above are denoted by the same reference characters and the description thereof will not be repeated.

According to the present embodiment, the display of a property having a dependency can be switched by an instruction of the viewer.

FIG. 11 is a block diagram showing a schematic structure of a system including the server 1 according to the second embodiment of the present invention. As shown in FIG. 11, by the CPU 101 controlling the respective units according to the parts information display program in addition to the structure described in the first embodiment, the server 1 is provided with a display property switching unit 26 which is display property switching means. This display property switching unit 26 fulfils the function of receiving specification by the viewer from the client terminal 3 functioning as a viewer terminal, regarding which properties are to be displayed among properties having dependencies.

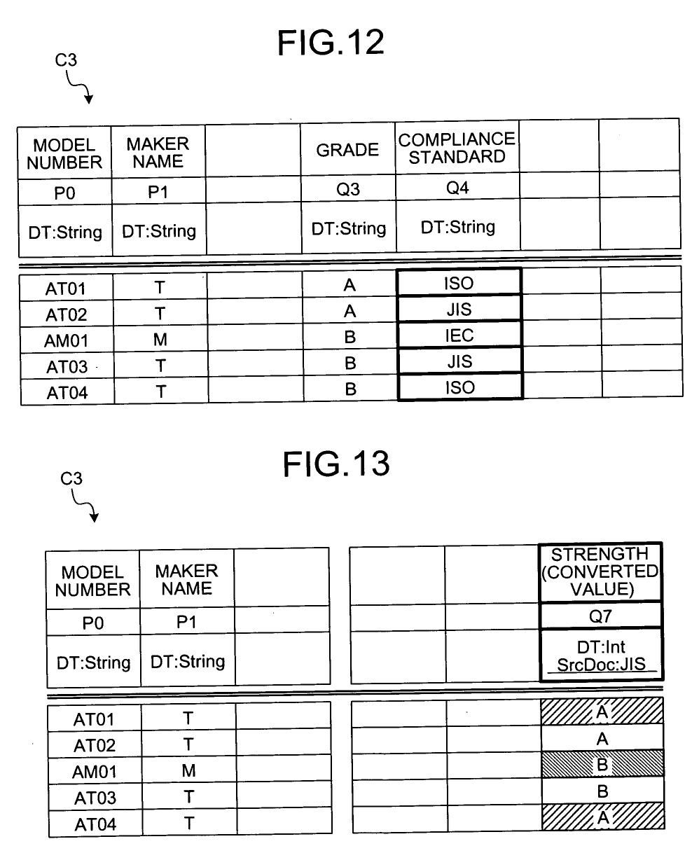

More specifically, upon receiving the specification by the viewer from the client terminal 3 functioning as the viewer terminal, the display property switching unit 26 specifies the display of any of an independent property and a dependent property and both of the properties as a search result with respect to the search result output unit 25. In the example shown in FIG. 10, a result when the viewer specifies the independent properties (Q3 and Q4) is shown in FIG. 12 and a result when the viewer specifies the dependent property (Q7) is shown in FIG. 13. FIG. 10 shows a case where the viewer specifies both of the independent properties and the dependent property (Q3, Q4, and Q7).

Thus, according to the present embodiment, execution of the display of the dependent property with the viewer's intention promotes the viewer to pay attention to the handling of the item automatically converted by the system.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A parts information display apparatus comprising:
a parts database configured to store
a dictionary which has an independent property and a dependent property which has a dependency in which a value thereof is determined by the independent property, and stores an attribute which defines a property characterizing a classification of parts and a value indicating nature of the property, and
an instance which has an instance value which is information of the parts described according to the dictionary;
an action database configured to store action data defining a display method of the dependent property according to an instance value of the independent property and a value of the attribute of the dependent property;
a search condition input unit configured to input a search condition;
a search unit configured to search the parts database with the search condition to acquire a property of corresponding parts data and an instance of the property;
a display determining unit configured to determine whether the property of the parts data corresponds to each of a property included in the instance value of the independent property and a property included in the value of the attribute of the dependent property, whose display method is defined in the action database, to determine the display method of the dependent property; and
a search result output unit configured to output the property of the parts data and the instance of the property which are acquired by the search unit, according to the display method of the dependent property.

2. The parts information display apparatus according to claim 1, wherein the display method of the dependent property is defined based on whether the instance value of the independent property and the value of the attribute of the dependent property coincide with each other.

3. The parts information display apparatus according to claim 1, wherein the display method of the dependent property is defined based on a combination of the instance value of the independent property and the value of the attribute of the dependent property.

4. The parts information display apparatus according to claim 1, wherein the display method of the dependent property is to switch a foreground format of a display of the dependent property.

5. The parts information display apparatus according to claim 1, wherein the display method of the dependent property is to switch a background format of a display of the dependent property.

6. The parts information display apparatus according to claim 1, wherein the display method of the dependent property is to display a specified wording by a pop-up when a mouse cursor is placed over a display field of the dependent property.

7. The parts information display apparatus according to claim 1, wherein the independent property is an item indicating “unit,” and the attribute of the dependent property is an item indicating “unit.”

8. The parts information display apparatus according to claim 1, wherein the independent property is an item indicating “standard,” and the attribute of the dependent property is an item indicating “standard.”

9. The parts information display apparatus according to claim 1, further comprising a display property switching unit configured to receive specification as to which property is displayed among the properties having dependencys to specify with respect to the search result output unit,
wherein the search result output unit outputs any one of the independent property and the dependent property as a search result, according to the specification received by the display property switching unit.

10. A parts information display apparatus comprising:
a parts database configured to store
a dictionary which has a class defining a hierarchical structure of parts data, an independent property, and a dependent property which has a dependency in which a value thereof is determined by the independent property, and stores a property which defines nature of the class and an attribute which defines values indicating nature of the class and the property, the dictionary having a hierarchical structure in which a lower classification class inherits a property of an upper classification class, and
an instance which has an instance value which is information of the parts described according to the dictionary;
an action database configured to store action data defining a display method of the dependent property according to an instance value of the independent property and a value of the attribute of the dependent property;
a search condition input unit configured to input a search condition;
a search unit configured to search the parts database with the search condition to acquire a property of corresponding parts data and an instance of the property;
a display determining unit configured to determine whether the property of the parts data corresponds to each of a property included in the instance value of the independent property and a property included in the value of the attribute of the dependent property, whose display method is defined in the action database, to determine the display method of the dependent property; and
a search result output unit configured to output the property of the parts data and the instance of the property which are acquired by the search unit, according to the display method of the dependent property.

11. The parts information display apparatus according to claim 10, wherein the display method of the dependent property is defined based on whether the instance value of the independent property and the value of the attribute of the dependent property coincide with each other.

12. A parts information display system comprising:
a parts database configured to store
a dictionary which has an independent property and a dependent property which has a dependency in which a value thereof is determined by the independent property, and stores an attribute which defines a property characterizing a classification of parts and a value indicating nature of the property, and
an instance which has an instance value which is information of the parts described according to the dictionary;
an action database configured to store action data defining a display method of the dependent property according to an instance value of the independent property and a value of the attribute of the dependent property;
an input unit configured to allow a viewer to input a search condition;
a search condition input unit configured to input the search condition;
a search unit configured to search the parts database with the search condition to acquire a property of corresponding parts data and an instance of the property;
a display determining unit configured to determine whether the property of the parts data corresponds to each of a property included in the instance value of the independent property and a property included in the value of the attribute of the dependent property, whose display method is defined in the action database, to determine the display method of the dependent property;
a search result output unit configured to output the property of the parts data and the instance of the property which are acquired by the search unit, according to the display method of the dependent property; and
a output unit configured to display the property of the parts data and the instance of the property which are acquired by the search unit and are output according to the display method of the dependent property.

13. A parts information display system comprising:
a parts database configured to store
a dictionary which has a class defining a hierarchical structure of parts data, an independent property, and a dependent property which has a dependency in which a value thereof is determined by the independent property, and stores a property which defines nature of the class and an attribute which defines values indicating nature of the classes and the property, the dictionary having a hierarchical structure in which a lower classification class inherits a property of an upper classification class, and
an instance which has an instance value which is information of the parts described according to the dictionary;
an action database configured to store action data defining a display method of the dependent property according to an instance value of the independent property and a value of the attribute of the dependent property;
an input unit configured to allow a viewer to input a search condition;
a search condition input unit configured to input the search condition;
a search unit configured to search the parts database with the search condition to acquire a property of corresponding parts data and an instance of the property;
a display determining unit configured to determine whether the property of the parts data corresponds to each of a property included in the instance value of the independent property and a property included in the value of the attribute of the dependent property, whose display method is defined in the action database, to determine the display method of the dependent property;
a search result output unit configured to output the property of the parts data and the instance of the property which are acquired by the search unit, according to the display method of the dependent property; and
a output unit configured to display the property of the parts data and the instance of the property which are acquired by the search unit and are output according to the display method of the dependent property.

14. A computer program product having a computer readable medium including programmed instructions for displaying parts information, wherein the instructions, when executed by a computer, cause the computer to perform:
creating a parts database configured to store
a dictionary which has an independent property and a dependent property which has a dependency in which a value thereof is determined by the independent property, and stores an attribute which defines a property characterizing a classification of parts and a value indicating nature of the property, and
an instance which has an instance value which is information of the parts described according to the dictionary;
creating an action database configured to store action data defining a display method of the dependent property according to an instance value of the independent property and a value of the attribute of the dependent property;
receiving a search condition;
searching the parts database with the search condition to acquire a property of corresponding parts data and an instance of the property;
judging whether the property of the parts data corresponds to each of a property included in the instance value of the independent property and a property included in the value of the attribute of the dependent property, whose display method is defined in the action database, to determine the display method of the dependent property; and
outputting the property of the parts data and the instance of the property which are acquired by the search unit, according to the display method of the dependent property.

15. A computer program product having a computer readable medium including programmed instructions for displaying parts information, wherein the instructions, when executed by a computer, cause the computer to perform:
creating a parts database configured to store
a dictionary which has a class defining a hierarchical structure of parts data, an independent property, and a dependent property which has a dependency in which a value thereof is determined by the independent property, and stores a property which defines nature of the class and an attribute which defines values indicating nature of the class and the property, the dictionary having a hierarchical structure in which a lower classification class inherits a property of an upper classification class, and
an instance which has an instance value which is information of the parts described according to the dictionary;
creating an action database configured to store action data defining a display method of the dependent property according to an instance value of the independent property and a value of the attribute of the dependent property;
receiving a search condition;
searching the parts database with the search condition to acquire a property of corresponding parts data and an instance of the property;
judging whether the property of the parts data corresponds to each of a property included in the instance value of the independent property and a property included in the value of the attribute of the dependent property, whose display method is defined in the action database, to determine the display method of the dependent property; and
outputting the property of the parts data and the instance of the property which are acquired by the search unit, according to the display method of the dependent property.

16. A parts information display method comprising:
creating a parts database configured to store
a dictionary which has an independent property and a dependent property which has a dependency in which a value thereof is determined by the independent property, and stores an attribute which defines a property characterizing a classification of parts and a value indicating nature of the property, and
an instance which has an instance value which is information of the parts described according to the dictionary;
creating an action database configured to store action data defining a display method of the dependent property according to an instance value of the independent property and a value of the attribute of the dependent property;
receiving a search condition;
searching the parts database with the search condition to acquire a property of corresponding parts data and an instance of the property;
judging whether the property of the parts data corresponds to each of a property included in the instance value of the independent property and a property included in the value of the attribute of the dependent property, whose display method is defined in the action database, to determine the display method of the dependent property; and
outputting the property of the parts data and the instance of the property which are acquired by the search unit, according to the display method of the dependent property.

17. A parts information display method comprising:
creating a parts database configured to store
a dictionary which has a class defining a hierarchical structure of parts data, an independent property, and a dependent property which has a dependency in which a value thereof is determined by the independent property, and stores a property which defines nature of the class and an attribute which defines values indicating nature of the class and the property, the dictionary having a hierarchical structure in which a lower classification class inherits a property of an upper classification class, and
an instance which has an instance value which is information of the parts described according to the dictionary;
creating an action database configured to store action data defining a display method of the dependent property according to an instance value of the independent property and a value of the attribute of the dependent property;
receiving a search condition;
searching the parts database with the search condition to acquire a property of corresponding parts data and an instance of the property;
judging whether the property of the parts data corresponds to each of a property included in the instance value of the independent property and a property included in the value of the attribute of the dependent property, whose display method is defined in the action database, to determine the display method of the dependent property; and
outputting the property of the parts data and the instance of the property which are acquired by the search unit, according to the display method of the dependent property.
